(19) United States
(12) Patent Application Publication
(10) Pub. No.: US 2013/0138643 A1
(43) Pub. Date: May 30, 2013

(54) METHOD FOR AUTOMATICALLY EXTENDING SEED SETS

(71) Applicants: Krishnan Ramanathan, Bangalore (IN); Govindaraju Vidhya, Bangalore (IN); Yogesh Sankarasubramaniam, Bangalore (IN)

(72) Inventors: Krishnan Ramanathan, Bangalore (IN); Govindaraju Vidhya, Bangalore (IN); Yogesh Sankarasubramaniam, Bangalore (IN)

(21) Appl. No.: 13/589,857

(22) Filed: Aug. 20, 2012

(30) Foreign Application Priority Data
Nov. 25, 2011 (IN) 4081/CHE/2011

(51) Int. Cl. G06F 17/30

(52) U.S. Cl. 707/732; 707/E17.06

(57) ABSTRACT

Provided is a method of automatically extending a seed set. Based on an input seed set, initial seed set candidates are generated. Also generated are categories that will vote on the initial seed set candidates. A weight for each category is determined and each initial seed set candidate is scored. The final seed set candidates are selected from the initial seed set candidates based on their scores.

### CLAIM FOR PRIORITY

The present application claims priority under 35 U.S.C 119 (a)-(d) to Indian Patent application number 4081/CHE/2011, filed on Nov. 25, 2011, which is incorporated by reference herein its entirety.

### BACKGROUND

The web has emerged as the most preferred way of searching for information for people who have access to the internet. With just a few clicks one could literally access thousands of documents that get uploaded each day. A simple internet search requires providing a few key word inputs to a search engine, which then displays the search results. Typically, a named entity (NE) search is done to search for desired information. A named entity, generally, refers to a word or groups of words, such as, the name of a company, a person, a location, a time, a date, a numerical value, etc.

A mechanism to make the search task convenient for a user is to perform an entity set expansion. By an entity set expansion, a given seed set is expanded to include other semantically similar items. The expanded seed set is then offered to the user for making a selection. To provide an example, if the user input is “Toy Story 2”, this seed set may be expanded to include “Toy Story 2 movie”, “Toy Story 2 games”, “Toy Story 2 merchandise” etc. The expanded seed set helps a user narrow down the search terms to his actual requirement. However, this mechanism has its own limitations.

### BRIEF DESCRIPTION OF THE DRAWINGS

For a better understanding of the solution, embodiments will now be described, purely by way of example, with reference to the accompanying drawings, in which:

FIG. 1 shows a flow chart of a method for automatically extending a seed set, according to an embodiment.

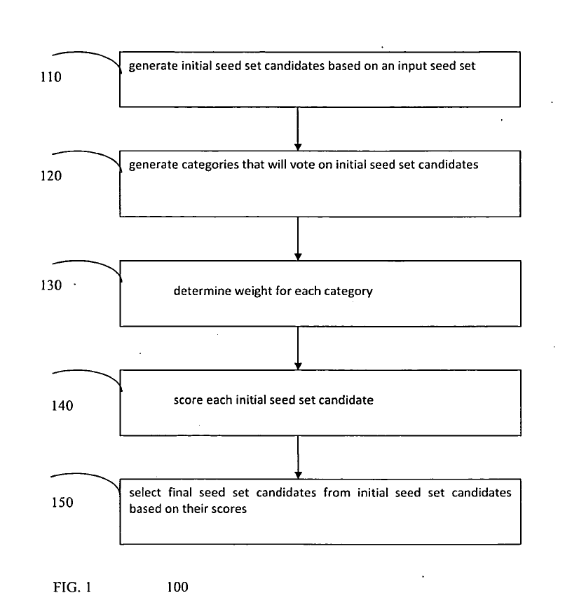

FIG. 2 illustrates a system for automatically extending a seed set, according to an embodiment.

### DETAILED DESCRIPTION OF THE INVENTION

As mentioned above, an initial seed set may be expanded by a search engine to offer a user an expanded seed set. The user can then make a selection of his choice from the expanded seed set which would be used by the search engine for performing a search. One of the limitations of this mechanism is that it does not take into account context of the seed set. For instance, if the user input is “Toy Story 2”, the expanded seed set may include “Toy Story 2 movie”, “Toy Story 2 games”, “Toy Story 2 merchandise” etc, but will not include seed set, such as “Movie for kids”, “Toy movies”, “Animation movies”, etc. Another limitation of the above method is that it also does not take into account a user's interests. For instance, a user's profile may give key indications related to his interest. To illustrate, let's assume that a user's profile indicates that he likes films like “Terminator”, “Transformers”, etc. The present seed set expansion methods do not is take into account user's interests prior to performing a seed set expansion. For example, in this case, a seed set expansion may include items such as “Transformers 2”, “Transformers 3”, “Transformers merchandise”, etc. but may not include terms like “Action films”, “Sci-fi movies”, etc.

Embodiments of the present solution provide a method and system for automatically extending a seed set that takes into a user's interest.

The method may be implemented in a computing system, such as, but not limited to, a desktop computer, a notebook computer, a server computer, a personal digital assistant (PDA), a mobile device, a touch pad, a television (TV) set, a docking device, and the like. The computing system may be connected to a computer network, such as, an intranet or the internet (World Wide Web), through wired (for example, co-axial cable) or wireless (for example, Wi-Fi) means.

The method makes use of Wikipedia categories. Wikipedia uses a category system, which provides links to all Wikipedia articles in the form of a hierarchy of categories. The categories allow articles to be placed in one or more groups, and allow those groups to be further categorized. Each article in Wikipedia belongs to at least one category. There are two kinds of categories in Wikipedia. Topic categories are named after a topic and usually share a name with the Wikipedia article on that topic. For example, category “Cricket” would contain all articles related to cricket. Set categories are created for a class of object. For example, category “Wines of France” contains articles whose subjects are wines of France.

At block 110, based on an input (seed set) received from a user, initial seed set candidates are generated. For example, if a user enters a text input “Toy Story 2” in a search engine, the method generates seed set candidates based on input “Toy Story 2”. The seed set generation may be performed in two ways. In one example, the web links on the Wikipedia pages of the seed input are considered as possible initial seed set candidates. To illustrate with the “Toy Story 2” input, the web links on the “Toy Story 2” Wikipedia web page, for instance, “Plot”, “Voice Cast”, “Production”, “Music”, “Awards”, etc. would be considered as initial seed set candidates.

In another example, other members of the categories to which the members in the seed set belong are considered as initial seed set candidates. To provide an illustration, let's assume that the user input is “Champagne wine”. Now “Champagne wine” belongs to broader category “French wine”, and there are additional categories, such as, “French Wine AOC”, “French Winemakers”, “Wine regions of France”, “Wineries of France” etc. in this broader category. In the present example, apart from pages in the category “Champagne wine”, these additional categories are also considered for generating a candidate seed set.

In a yet another example, a user's profile is taken into consideration for generating initial seed set candidates. Therefore, in one use case, the aforementioned examples, may also consider, in addition, user profile information for generating seed set candidates. To illustrate, let's assume that a user's profile indicate that he also likes movies “Winnie the Pooh” and “Cars”. This additional movie information may also be considered for generating a candidate seed set. A user's profile details may be obtained from the data stored on his computing device (such as desktop, laptop, touch pad, mobile, PDA, and the like) or any other computing device, such as those maintained by a social networking site (for instance, a server computer).

At block 120, after a pool of seed set candidates has been generated, the candidates are evaluated for inclusion in the set. This is performed by generating a list of categories that will participate in the Wikipedia category voting. The list of categories that will participate is determined by taking the union of all the categories, Cₙ, to which each candidate belongs. Categories will vote on the initial seed set candidates.

At block 130, each category is given a weight. The weight of each category is determined based on the number of pages in that category and the number of seed inputs that belong to the category. To illustrate using the above “Champagne wine” example, if category “Wine regions of France” contains more pages then other categories, this category will be given more weight. In another situation, if category “Wineries of France” contains more number of seed inputs than other categories, this category will be given more weight. The aforesaid examples represent simple situations and mentioned for the purpose of illustration only. The weight for a category may be calculated as follows

$$w {c}_{i} = \frac{1}{{log}_{10} n {c}_{i}} * {n}_{i}$$

where wcᵢ and ncᵢ denote the weight of a category and the number of Wikipedia pages in that category respectively. The subscript is the index of the category. ‘n’ denotes the number of seed inputs that belong to the category i.

Category weighting, as described above, ensures that relevant categories are given more weight than categories that are too broad and general.

In an example, the categories participating in the voting are displayed through a graphical user interface (GUI) and the user is given the option of deleting categories or modifying the weights of the categories.

At block 140, a score is computed for each initial seed set candidate generated at block 110. The score is the weighted sum of the category weights for the candidate for those categories of which the candidate is a member of. The score for each candidate is calculated as follows:

$$Score = {\sum }_{i = 1}^{N} w {c}_{i} * m {c}_{i}$$

where N is the number of categories, wcᵢ is the weight of category i and mcᵢ is 1 if the candidate is a member of the i^{th} Wikipedia category, 0 otherwise. The role of mcᵢ is to ensure that categories only participate in the voting of a candidate if the candidate is a part of that category.

At block 150, after each seed set candidate has been scored, the scores for all the candidates are evaluated. A final seed set candidates is selected from the initial seed set candidates based on their scores. In an example, the candidates are sorted by the descending order of scores. The candidates with the highest scores are then included in the expanded set.

In another example, the user can specify a threshold for the score. A candidate set members below this score is rejected and, therefore, not included in the set. In yet another example, the user can specify the number of members (say, N) in the set. The top N candidates from the previous step are then selected.

The expanded set is displayed on a display device. A user can then make a selection from the expanded set.

In another example, the method may be used to output multiple sets instead of just one set. The number of sets is determined by the common categories shared by the seed set. For instance, given the input seed set {Ajit Wadekar, Sunil Gavaskar, Ravi Shastri} the Wikipedia categories in which they intersect are India test cricketers, India test captains, West Zone cricketers and Arjuna Awardees. Each of these sets will have different members and the non-intersecting categories are is used in the voting of the membership as described above. To provide another example, given the input seed set {Socrates, Plato} the different sets that could be output are: Ancient Greek philosophers, Ancient Athenian philosophers, etc. each having different entities. Thus if the user requests multiple sets, the proposed solution will determine the number of sets and output those sets with their members. In this case, the final seed set candidates will be displayed as multiple seed sets.

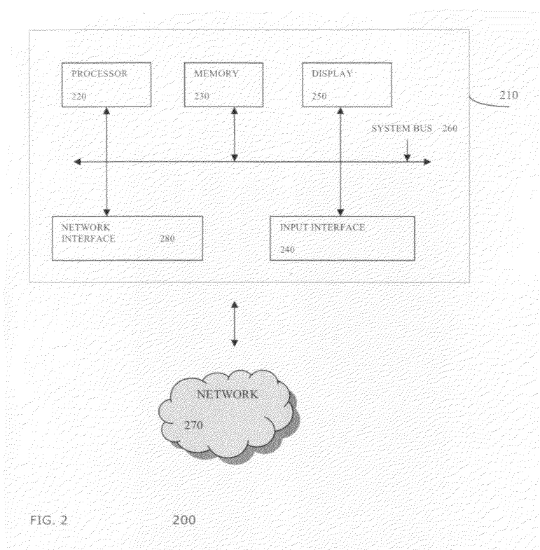

FIG. 2 illustrates a system for automatically extending a seed set, according to an embodiment.

The system 200 includes a computing system 210 connected to a computer network 270. The computing system 210 may be, but not limited to, a desktop computer, a notebook computer, a server computer, a personal digital assistant (PDA), a mobile device, a touch pad, a television (TV) set, a docking device, and the like.

Computing system 210 may include a processor 220, for executing machine readable instructions, a memory (storage medium) 230, for storing machine readable instructions (such as, a web browser module), an input interface 240 and a display 250. These components may be coupled together through a system bus 260.

Processor 220 is arranged to execute machine readable instructions. The machine readable instructions may be in the form of a web browser module 240. In an example, processor 220 executes machine readable instructions to: generate initial seed set candidates based on the input seed set; generate categories that will vote on the initial seed set candidates; determine weight for each category; score each initial seed set candidate; and select final seed set candidates from the initial seed set candidates based on their scores.

The memory 230 may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. The memory 230 may include modules, such as, but not limited to, a web browser module 240. The memory may also store user profile information, such as his likes or dislikes.

The web browser module may be used to access, retrieve and view documents and other resources on the Internet or an intranet. Some major web browser modules include Windows Internet Explorer, Mozilla Firefox, Google Chrome, and Opera.

The input interface 240 may be used to provide an initial seed set input to the computing system 210. The input interface 240 may include an input device, such as a keyboard or a mouse, and other user interaction mechanisms, such as a touch interface, a voice interface (such as microphone), a gesture interface, etc.

The display device 250 may be any device that enables a user to receive visual feedback. For example, the display may be a liquid crystal display (LCD), a light-emitting diode (LED) display, a plasma display panel, a television, a computer monitor, and the like.

The computer network 270 may be the internet or an intranet. The computing system 210 may be connected to a computer network 270, such as, an intranet or the internet (World Wide Web), through wired (for example, co-axial cable) or wireless (for example, Wi-Fi) means. A network interface controller 280 is used to connect the computing system 210 to the computer network 270.

It is clarified that the term “module”, as used in this document, may mean to include a software component, a hardware component or a combination thereof. A module may include, by way of example, components, such as software components, processes, functions, attributes, procedures, drivers, firmware, data, databases, and data structures. The module may reside on a volatile or non-volatile storage medium and configured to interact with a processor of a computer system.

It would be appreciated that the system components depicted in FIG. 2 are for the purpose of illustration only and the actual components may vary depending on the computing system and architecture deployed for implementation of the present solution. The various components described above may be hosted on a single computing system or multiple computer systems, including servers, connected together through suitable means.

In one example, during an operative phase, the computing system 210 is connected to a search engine portal through a network, such as the internet, and a user provides an input seed set to the search engine through a web browser stored on the computing system 210. The proposed solution may be implemented on the computing system 210 or another computing device such as a server computer used to host a search engine portal.

Examples of the proposed solution leverages Wikipedia categories to vote on the membership of set candidates in a different way leading to better expansion of the seed entities. They adapt as Wikipedia changes and do not require a precurated dataset like Bayesian sets. They also do not require a web crawler or search engine infrastructure.

It will be appreciated that the embodiments within the scope of the present solution may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A computer-implemented method of automatically extending a seed set, comprising:
generating initial seed set candidates based on an input seed set;
generating categories that will vote on the initial seed set candidates;
determining weight for each category;
scoring each initial seed set candidate; and
selecting final seed set candidates from the initial seed set candidates based on their scores.

2. A method according to claim 1, further comprising displaying the final seed set candidates.

3. A method according to claim 1, wherein the initial seed set candidates includes web links on Wikipedia pages corresponding to the input seed set.

4. A method according to claim 1, wherein the initial seed set candidates includes other members of categories to which members in the input seed set belong.

5. A method according to claim 1, wherein a user's profile is taken into consideration for generating the initial seed set candidates.

6. A method according to claim 1, wherein generating categories that will vote on the initial seed set candidates includes taking a union of all categories to which each initial seed set candidate belong.

7. A method according to claim 1, wherein weight for a category is based on the number of pages in the category and number of input seed set that belong to the category.

8. A method according to claim 1, further comprising displaying the categories that will vote on the initial seed set candidates.

9. A method according to claim 1, wherein weight for a category can be modified by a user.

10. A method according to claim 1, wherein score of an initial seed set candidate is weighted sum of category weights for the initial seed set candidate for those categories of which the initial seed set candidate is a member of.

11. A method according to claim 1, wherein the final seed set candidates includes the initial seed set candidates having highest scores.

12. A method according to claim 1, wherein the final seed set candidates is displayed as multiple seed sets.

13. A system for automatically extending a seed set, comprising:
an input interface to receive an input seed set input;
a processor to:
generate initial seed set candidates based on the input seed set;
generate categories that will vote on the initial seed set candidates;
determine weight for each category;
score each initial seed set candidate; and
select final seed set candidates from the initial seed set candidates based on their scores.

14. A system of claim 13, further comprising:
a display device to display the final seed set candidates.

15. A computer program product for automatically extending a seed set, the computer program product comprising:
a computer readable storage medium having computer usable program code embodied therewith, the computer usable program code comprising:
computer usable program code that receives an input seed set input;
computer usable program code that generates initial seed set candidates based on the input seed set;
computer usable program code that generates categories that will vote on the initial seed set candidates;
computer usable program code that determines weight for each category;
computer usable program code that scores each initial seed set candidate; and
computer usable program code that selects final seed set candidates from the initial seed set candidates based on their scores.
